(19) United States
(12) Patent Application Publication
(10) Pub. No.: US 2018/0058356 A1
(43) Pub. Date: Mar. 1, 2018

(54) CONTROL DEVICE FOR ENGINE, AND ENGINE

(71) Applicant: Yanmar Co., Ltd., Osaka-shi, Osaka-fu (JP)

(72) Inventors: Hirotoshi KIHARA, Osaka-shi (JP); Hirotaka NAKAMURA, Osaka-shi (JP); Shiro TANIHARA, Osaka-shi (JP); Kyoko HASHIMOTO, Osaka-shi (JP); Makoto ASAI, Osaka-shi (JP); Takafumi KUBO, Osaka-shi (JP)

(73) Assignee: Yanmar Co., Ltd., Osaka-shi, Osaka-fu (JP)

(21) Appl. No.: 15/558,277

(22) PCT Filed: Mar. 11, 2016
(86) PCT No.: PCT/JP2016/057845

§ 371 Date: Sep. 14, 2017

(30) Foreign Application Priority Data
Mar. 17, 2015 (JP) 2015-053181

(51) Int. Cl. F02D 41/14

(52) U.S. Cl. CPC F02D 41/1402; F02D 2200/1002; F02D 2200/024

(57) ABSTRACT

In cases where a control device determines that a load is continuously less than a predetermined value for a predetermined period, the control device executes a first control to maintain the engine speed at a first rotation speed or higher, and when the control device determines that the load reached the predetermined value within the predetermined time, the control device executes a second control to maintain the engine speed at a second rotation speed or higher, which is higher than the first rotation speed. This provides a control device for an engine and an engine, which can restrain activation of an oil pressure switch attributed to an oil temperature.

### TECHNICAL FIELD

The present invention relates to a control device for an engine and relates to an engine.

### BACKGROUND ART

Traditionally, there has been known a structure in which monitoring of an oil pressure by an oil pressure switch is suspended for a predetermined time, at a time of rapid deceleration or rapid acceleration (e.g., Patent Literature 1; hereinafter, PTL 1 ). Further, there has been known a structure to change a threshold value of an oil pressure switch according to an engine speed (e.g., Patent Literature 2; hereinafter, PTL2).

### CITATION LIST

### Patent Literature

PTL1: Japanese Patent Application Laid-Open No. H11-324630 (1999)

PTL2: Japanese Patent Application Laid-Open No. 2000-240420

### SUMMARY OF INVENTION

### Technical Problem

In a state in which a high load is applied, the fuel consumption increases and the engine is in a high-temperature state, which raises the oil temperature and decreases the viscosity of the oil. Therefore, a decrease in the engine speed decreases the rotating speed of an oil pump whose drive source is a crank shaft, which may consequently lead to an excessive decrease in the oil pressure. From this state, if the rotation speed is decreased too much with a rapid decrease in the load, the oil pressure switch may activate, stopping the engine, even though the oil is not run out.

However, PTL 1 lacks description regarding activation of the oil pressure switch attributed to the oil temperature, and no information is available as to measures against activation of the oil pressure switch under the influence of the oil temperature, even by referring to PTL 1. Further, in the technology of PTL 2, an oil pressure sensor is necessary instead of the oil pressure switch, which increases the production costs.

In view of the above problem, an object of the present invention is to provide a control device for an engine and an engine, which can restrain activation of an oil pressure switch attributed to an oil temperature.

### Solution to Problem

To achieve the above object, a control device for an engine according to one mode of the present invention may include:

a load specifying unit configured to specify an engine load; and
a control unit configured to receive a signal indicative of the engine load from the load specifying unit, the control unit being capable of executing a first control which sets an allowable minimum rotation speed of an engine speed to a first rotation speed and a second control which sets the allowable minimum rotation speed of the engine speed to a second rotation speed which is higher than the first rotation speed,
wherein
the control device executes the first control when the control device determines that the engine load is a predetermined value or lower continuously for a predetermined time, and on the other hand, executes the second control when the control device does not determine that the engine load is the predetermined value or lower continuously for the predetermined time.

### Advantageous Effects of Invention

With the present invention, activation of the oil pressure switch attributed to the oil temperature can be restrained, and as the result, occurrence of unnecessary alarms and engine stop can be avoided.

### BRIEF DESCRIPTION OF DRAWINGS

FIG. 1 is a schematic structure diagram showing a part of an engine of one embodiment of the present invention.

FIG. 2 is a flowchart showing an example of rotation speed control by a control device.

FIG. 3 is a diagram showing an oil pressure characteristic associated with variation in the rotation speed, in one example experiment.

### DESCRIPTION OF EMBODIMENTS

A control device for an engine, according to one mode of the present invention may include: a load specifying unit configured to specify an engine load; and a control unit configured to receive a signal indicative of the engine load from the load specifying unit, the control unit being capable of executing a first control which sets an allowable minimum rotation speed of an engine speed to a first rotation speed and a second control which sets the allowable minimum rotation speed of the engine speed to a second rotation speed which is higher than the first rotation speed, wherein the control device executes the first control when the control device determines that the engine load is a predetermined value or lower continuously for a predetermined time, and on the other hand, executes the second control when the control device does not determine that the engine load is a predetermined value or lower continuously for a predetermined time.

With this structure, the second control is performed and the engine speed is maintained at the second rotation speed or higher, which is higher than the first rotation speed, in cases where the control device does not determine that the engine load is a predetermined value or lower continuously for a predetermined time. Therefore, the engine speed can be prevented from dropping below the second rotation speed higher than the first rotation speed, from the state in which the engine load is high. This can prevent a drop of the engine speed to the rotation speed that leads to detection of a low oil pressure, from the state in which the oil temperature of the engine oil is high and the viscosity of the engine oil is low due to a high engine load and a high-temperature state of the engine. Thus, activation of the oil pressure switch attributed to the oil temperature can be restrained.

Further, an engine according to a second mode of the present invention may include the control device for an engine according to the first mode.

Since the structure include the control device for an engine according to the first aspect, activation of the oil pressure switch attributed to the oil temperature can be restrained.

In the following, the present invention is described in detail with reference to the illustrated embodiments.

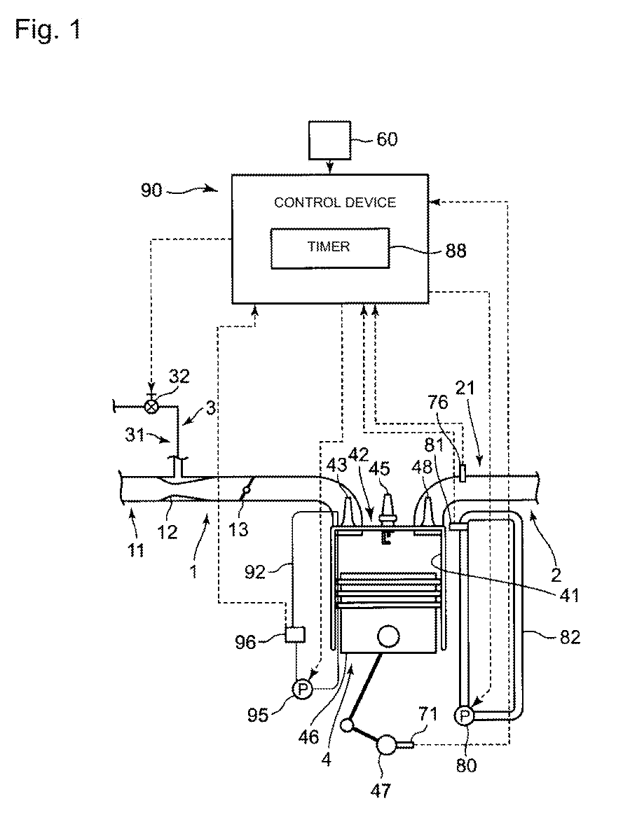

FIG. 1 is a schematic structure diagram showing a part of an engine of one embodiment of the present invention.

This engine is a gas engine that uses a gaseous fuel gas such as natural gas and the like. This engine includes an air-supply channel 1, an exhaustion channel 2, a fuel-gas-supply channel 3, and an engine main body 4.

The air-supply channel 1 includes an air-supply tube 11, a venturi 12, and a throttle valve 13. The air-supply tube 11 supplies a fuel-air mixture generated by mixing the fuel gas with the air taken in from outside. The venturi 12 causes a differential pressure between the fuel gas and the air inside the fuel-gas-supply channel. The throttle valve 13 adjusts the amount of the fuel-air mixture supplied.

The exhaustion channel 2 includes an exhaustion tube 21. The exhaustion tube 21 is configured to guide exhaust gas generated by combusting the fuel-air mixture in a later-described combustion chamber 41 to outside the engine. The fuel-gas-supply channel 3 includes a fuel-gas-supply tube 31 and a fuel-gas-supply amount adjusting valve 32. The fuel-gas-supply tube 31 is configured to guide the fuel gas to the air-supply channel 1. Further, the fuel-gas-supply amount adjusting valve 32 plays a role of adjusting the amount of fuel gas contained in the fuel-air mixture.

The engine main body 4 includes a combustion chamber 41, a cylinder head 42, an air-supply valve 43, a spark plug 45, a piston 46, a crank shaft 47, and an exhaustion valve 48. The combustion chamber 41 is a chamber for combusting the fuel-air mixture. Further, the air-supply valve 43 performs open/close operation in the cylinder head 42 to communicate or block the air-supply tube 11 and the combustion chamber 41 with/from each other. The spark plug 45 generates a spark for combusting fuel-air mixture supplied to the combustion chamber 41. The piston 46 reciprocates in up-and-down directions, with the combustion and expansion of the fuel-air mixture supplied in the combustion chamber 41, and the crank shaft 47 makes rotary motion by the reciprocating motion of the piston 16. Further, the exhaustion valve 48 performs open/close operation in the cylinder head 42 to communicate or block the exhaustion tube 21 and the combustion chamber 41 with/from each other.

The engine further includes an engine speed sensor 71, an exhaust gas temperature sensor 76, and a control device 90. The engine speed sensor 71 detects an engine speed by detecting the number of teeth of a gear provided to the crank shaft 47, and the exhaust gas temperature sensor 76 is provided to the exhaustion tube 21 and detects the temperature of exhaust gas.

To the control device 90, signals from the above described various sensors 71 and 76 and signals from an operation unit 60 structured by, for example, a remote controller and the like are input. Although details are omitted, the control device 90 is configured to suitably control the opening and the like of the throttle valve 13 based on signals from the above various sensors 71 and 76, or signals from the operation unit 60, thereby performing control of the engine speed and the like. It should be noted that the control device 90 performs not only the control of the engine, but also control of a later-described heat pump. The control device 90 may be structured by a plurality of members arranged apart from each other.

The engine further includes: a cooling water pump 80, a cooling water temperature sensor 81, an oil pump 95, and an oil pressure switch 96. The cooling water pump 80 operates under control of the control device 90, during operation of the engine, and circulates cooling water in a cooling water channel 82 to cool each unit of the engine. Further, the cooling water temperature sensor 81 is provided in the cooling water channel 82, and detects the temperature of the engine by measuring the temperature of the cooling water. The oil pump 95 operates during operation of the engine with the crank shaft 47 as the drive source, and circulates lubricant oil in a lubricant oil channel 92 to restrain seizure of each slide portion of the engine. The oil pressure switch 96 outputs to the control device 90 a signal indicative of lack of oil pressure when the oil pressure is less than a predetermined value.

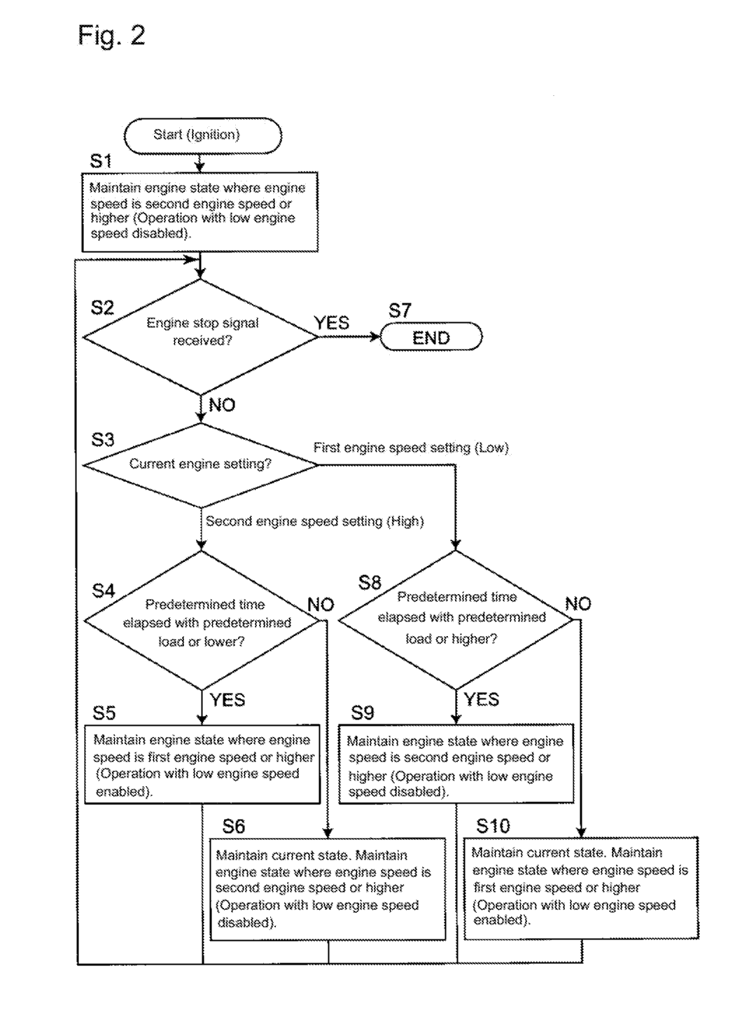

FIG. 2 is a flowchart showing an example of rotation speed control by a control device 90.

When the control device 90 receives an engine start signal, the process proceeds to step S1. In step S1, the control device 90 sets the allowable minimum rotation speed to the second rotation speed which is higher than the first rotation speed, for a predetermined time from the reception of the engine start signal. Then, the control device 90 confirms if a stop signal in step S2 is received. If the signal is not received, the process proceeds to step S3. If received the process proceeds to step S7 to perform an engine stop control.

The control device 90 confirms the setting of the current allowable minimum rotation speed in step S3. If the second rotation speed is set, the proceeds to step S4. If the first rotation speed is set, the process proceeds to step S8.

In step S4, the control device 90 determines whether a state of a predetermined load or lower has lasted a predetermined time. If the determination condition is met, the process proceeds to step S5. If the determination condition is not met, the process proceeds to step S6. In step S5, the control device 90 updates the allowable minimum rotation speed to the first rotation speed and returns to step S2 to repeat the series of steps. In step S6, the control device 90 leaves the allowable minimum rotation speed at the second rotation speed and returns to step S2 to repeat the series of steps.

On the other hand, in step S8, the control device 90 determines whether a state of a predetermined load or higher has lasted a predetermined time. If the determination condition is met, the process proceeds to step S9. If the determination condition is not met, the process proceeds to step S10. In step S9, the control device 90 updates the allowable minimum rotation speed to the second rotation speed and returns to step S2 to repeat the series of steps. In step S10, the control device 90 leaves the allowable minimum rotation speed at the first rotation speed and returns to step S2 to repeat the series of steps.

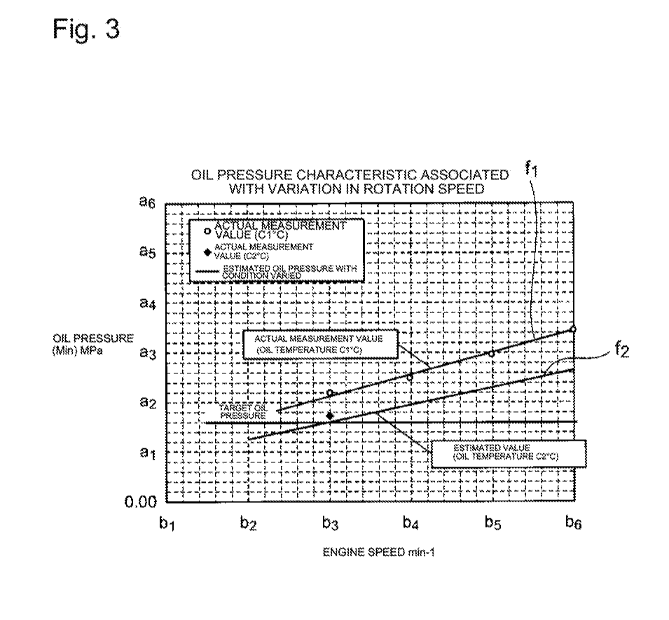

FIG. 3 is a diagram showing an oil pressure characteristic associated with variation in the rotation speed, in one example experiment.

In FIG. 3, the vertical axis represents an oil pressure of the engine oil, and the horizontal axis represents the engine speed. Further, in FIG. 3, f1 indicates a primary approximate function based on an actual measurement value at a temperature of C1[° C.], and f2 indicates an estimated function which is roughly parallel displacement of the primary approximate function of f1 based on an actual measurement value of the engine speed b3 with the temperature C2[° C.] higher than the above temperature C1[° C.]. Further, the target oil pressure indicated in FIG. 3 is a threshold value for the oil pressure switch 96 to determine an oil pressure abnormality.

As shown in FIG. 3, with the actual measurement values indicated by f2 with high engine oil temperatures, the viscosity of the engine oil is low due to high temperatures. Therefore, the oil pressure is lower as compared to those of the actual measurement values indicated by f1 with lower engine oil temperatures. Therefore, in the example of FIG. 3 where the engine is in a high-temperature state due to a large load and the engine oil temperature is C2[° C.] as the result, the oil pressure drops to the target oil pressure at the rotation speed b3 [min⁻¹] of FIG. 3, thus activating the oil pressure switch, even though the amount of the engine oil has not reached the out-of-oil amount.

In the above embodiment, the allowable minimum rotation speed is maintained at the second rotation speed with a higher engine speed than the first rotation speed, for a period from the early stage of the start of the engine until elapse of a predetermined time with a state of a predetermined load or lower continued. Therefore, the engine speed can be prevented from dropping below the second rotation speed, from the state in which the engine load is high. This can prevent a drop of the engine speed to the rotation speed that leads to detection of a low oil pressure, from the state in which the oil temperature of the engine oil is high and the viscosity of the engine oil is low due to a high engine load and a high-temperature state of the engine. Thus, malfunction of the oil pressure switch attributed to the oil temperature can be restrained.

It should be noted that, in the above embodiment, whether or not a load has become a predetermined load may be determined based on the pressure of a gas refrigerant on an ejection side of a compressor, which is detected by a pressure sensor in a refrigerant circuit (not shown), in cases where the engine is used for driving a heat pump. Further, the load may be determined by the power generation amount, in cases where the engine is used for power generation.

Further, in the above embodiment, the control of the engine speed is done through a control of the opening of the throttle valve 13. However, in cases where the engine is a gasoline engine or a diesel engine, the control of the engine speed may be done through a control of a fuel injection amount of a fuel injection apparatus. Further, the engine speed may be controlled through any other known technique.

It goes without saying that, the above first rotation speed and the second rotation speed may be freely varied according to the specification, provided that the second rotation speed is higher than the first rotation speed. Further, it goes without saying that the other various predetermined amounts such as the first predetermined time may also be freely variable. Further, in the above embodiment, the engine is a gas engine; however, the engine may be a gasoline engine, a diesel engine, or any other engine other than a gas engine. It goes without saying that two or more structures out of the entire structure described in the above embodiments and modification may be combined to construct a new embodiment.

Preferred embodiments of the present invention are thus sufficiently described with reference to attached drawings; however, it is obvious for a person with ordinary skill in the art to which the present invention pertains that various modification and changes are possible. Such a modification and changes, unless they depart from the scope of the present invention as set forth in claims attached hereto, shall be understood as to be encompassed by the present invention.

The entire disclosure of the specification, drawings, and claims of Japanese patent application No. 2015-53181 filed on Mar. 17, 2015 is incorporated in this specification by reference.

### REFERENCE SIGNS LIST

72 torque sensor
90 control device
95 hydraulic pump
96 oil pressure switch

1. (canceled)

2. (canceled)

3. A control device for an engine, the control device comprising:
a load specifying unit configured to output a signal indicative of an engine load of an engine; and
a control unit configured to receive the signal from the load specifying unit and:
when the engine load is at or below a predetermined value and has been at or below the predetermined value for at least a predetermined period of time, set an allowable minimum rotation speed of the engine to a first rotation speed; and
when the engine load is not at or below the predetermined value or has not been at or below the predetermined value for at least the predetermined period of time, set the allowable minimum rotation speed of the engine to a second rotation speed that is greater than the first rotation speed, the second rotation speed being greater than an engine speed that leads to detection of a low-oil pressure state.

4. The control device according to claim 3, comprising the engine.
